(19) United States
(12) Patent Application Publication
(10) Pub. No.: US 2023/0329141 A1
(43) Pub. Date: Oct. 19, 2023

(54) CONVERSION KIT FOR A SEEDING RESIDUE MANAGING DEVICE

(71) Applicant: AG FOCUS, LLC, Lexington, IL (US)

(72) Inventor: Bruce W. Freed, Lexington, IL (US)

(21) Appl. No.: 18/132,624

(22) Filed: Apr. 10, 2023

Related U.S. Application Data
(60) Provisional application No. 63/329,052, filed on Apr. 8, 2022.

(51) Int. Cl. A01C 14/00; A01C 5/06

(52) U.S. Cl. CPC A01C 14/00; A01C 5/064

(57) ABSTRACT

A conversion kit for a debris clearing device, having a mounting frame with a device section for receipt of a seeding unit mounted debris clearing device. The device section has a first mount adapted for connection of a seeding unit mounted debris clearing device to the device section of the mounting frame. A tool bar section is spaced from the device section. The tool bar section has a second mount for attachment of the mounting frame to a tool bar. A central section connects the device section and the tool bar section. The conversion kit allows a seeding unit mounted debris clearing device to be mounted to the device section of the conversion kit and then mounted to a tool bar instead of a seeding unit of an agricultural device.

### CROSS REFERENCE TO RELATED APPLICATION

This application claims priority to U.S. Provisional Application No. 63/329,052 filed Apr. 8, 2022, which is incorporated herein by reference in its entirety.

### TECHNICAL FIELD

The present invention relates generally to methods and devices for clearing crop debris for use with planters and other agricultural implements. In particular, the present invention relates to a conversion kit for mounting a seeding unit mounted residue managing device or crop clearing apparatus to the toolbar.

### BACKGROUND OF THE INVENTION

The problem with many industry debris or residue managers is that they are mounted to the face plate of a planter. When they encounter unevenness in fields, they negatively affect the planter's performance.

### SUMMARY OF THE INVENTION

In general terms, this invention provides a conversion kit that allows the debris or residue manager to be mounted to the tool bar. Mounting the residue manager to the toolbar takes the weight off the row unit and doesn't negatively affect the ride of the seeding planting unit.

The present invention provides a conversion kit for a debris clearing device, having a mounting frame with a device section for receipt of a seeding unit mounted debris clearing device. The device section has a first mount adapted for connection of a seeding unit mounted debris clearing device to the device section of the mounting frame.

A tool bar section is spaced from the device section. The tool bar section has a second mount for attachment of the mounting frame to a tool bar. A central section connects the device section and the tool bar section.

The conversion kit allows a seeding unit mounted debris clearing device to be mounted to the device section of the conversion kit and then mounted to a tool bar instead of a seeding unit of an agricultural device.

The conversion kit is also designed to be easy to ship and assemble. As disclosed, there are only six pieces that interconnect when assembled. Due to the design, the pieces can be stacked and nested for shipping reducing the cost of shipping.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a side view of a conventional planter unit.

FIG. 2 is a perspective view of the debris clearing apparatus shown in FIG. 1.

FIG. 3 is a perspective view of the conversion kit of the present invention.

FIG. 4 is a side view of the conversion kit of the present invention.

FIG. 5 is an end view of the conversion kit of the present invention.

FIG. 6 is a top view of the conversion kit of the present invention.

FIG. 7 is a side view of a planter unit with the conversion kit of the present invention attached.

FIG. 8 is a perspective view of a second embodiment of the present invention.

FIG. 9 is a perspective view of a second embodiment of the present invention.

### DETAILED DESCRIPTION OF A PREFERRED EMBODIMENT

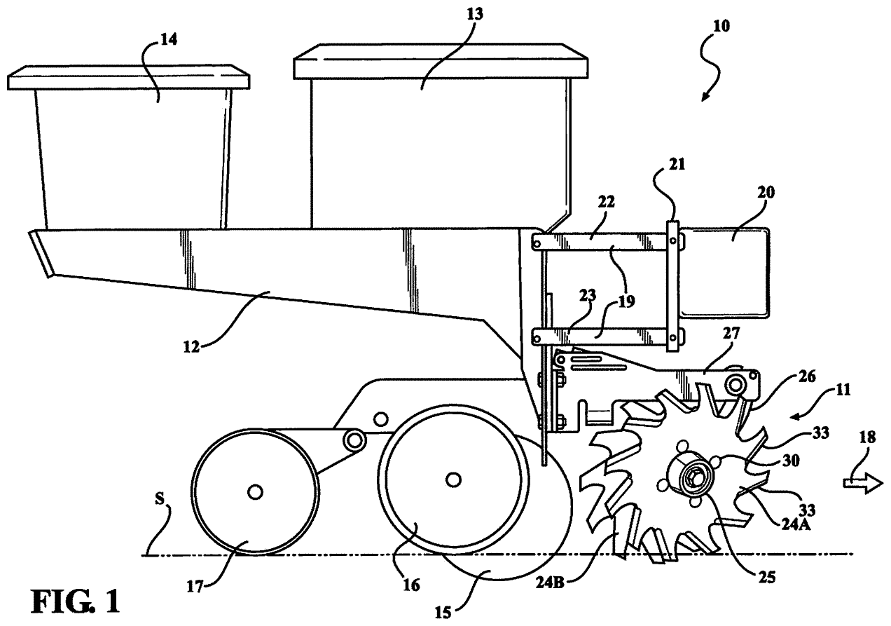

Referring to FIG. 1, there is shown a side elevation view of a conventional planter row unit 10 to which is directly mounted a residue manager or debris clearing apparatus 11. The planter unit 10 and debris clearing apparatus 11 are disclosed in U.S. Pat. No. 10,051,772, which is incorporated herein by reference. The planter unit 10 may include many elements, but for purposes of describing the present invention, the planter unit 10 is shown as including a frame 12 to which are mounted a seeding unit 13, an insecticide hopper 14, and plural ground engaging members. The illustrated ground engaging members include a pair of laterally spaced furrow opening discs (where one disc is shown as element 15), plural gauge wheels (where one gauge wheel is shown as element 16), and a trailing furrow closing wheel 17. All the ground engaging members 15, 16, 17 either ride on the surface of the soil S or penetrate the soil S as part of the seed planting operation. The planter unit 10 is shown as traveling in the direction of arrow 18 during operation.

Attached to a forward portion of the planter unit's frame 12 is a pivoting parallel linkage arrangement 19 for facilitating mounting of the planter row unit 10 to the tool bar 20 of an agricultural implement. The planter unit 10 is coupled to the tool bar 20 by means of the pivoting parallel linkage arrangement 19 and a mounting plate 21. The mounting plate 21 is secured to an aft surface of the tool bar 20 by conventional couplers, such as U-bolts (not shown in the figure for simplicity). The parallel linkage arrangement 19 includes links 22, 23 pivotally coupled at their respective aft ends to a forward portion of the planter row unit's frame 12 and at their respective forward ends to the mounting plate 21 to allow for vertical displacement between the tool bar 20 and the planter row unit 10.

Attached to a forward portion of the planter row unit's frame 12 is the residue manager or debris clearing apparatus 11. The debris clearing apparatus 11 can be mounted to the frame 12 in the manner disclosed in Applicant's U.S. Pat. No. 8,393,407, which is incorporated herein by reference. The debris clearing apparatus 11 can also be used with other agricultural implements, such as fertilizer applicators, strip till machines, seeders, and soil testing implements, and the configuration of the mounting brackets used to attach the apparatus to such implements will vary depending on the implement.

The debris clearing apparatus 11 includes a pair of substantially flat discs 24A, 24B that are rotatably mounted via a hub 25 to a bracket arm 26 attached to a mounting bracket 27 on the implement. The discs 24A, 24B have a center hole for receiving the hub 25 and a plurality of mounting holes for receiving mounting bolts 30. The discs 24A, 24B are mounted to the bracket arm 26 for rotation about generally horizontal axes with the discs 24A, 24B toed-in toward each other relative to a direction of travel 18 of the implement. In this mounting arrangement, a geometric plane containing the first disc 24A intersects a geometric plane containing the second disc 24B.

The flat discs 24A, 24B each have a first side and an opposing second side. A plurality of teeth 32 extend from a periphery of each disc 24A, 24B. In the illustrated embodiment, each disc 24A, 24B has 12 teeth equally spaced around the disc at 30-degree intervals.

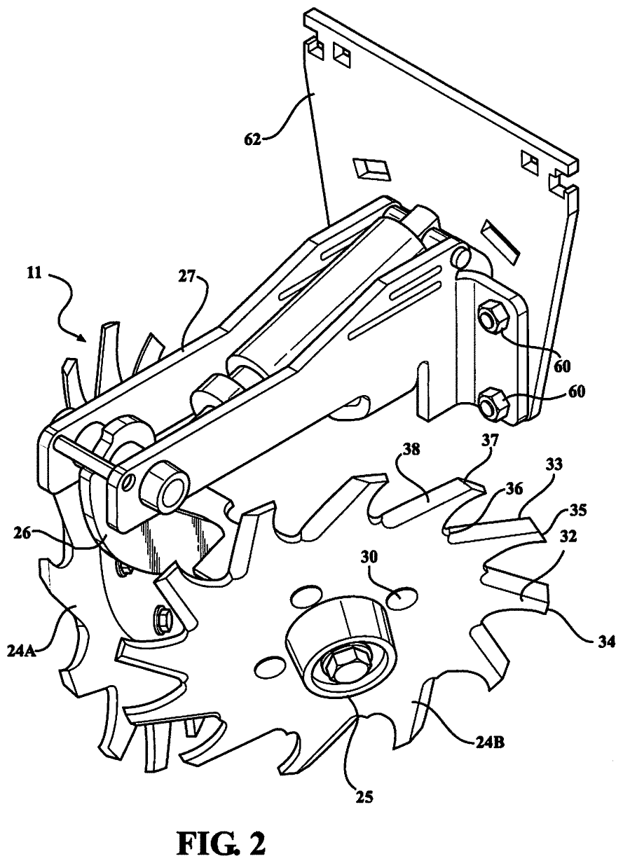

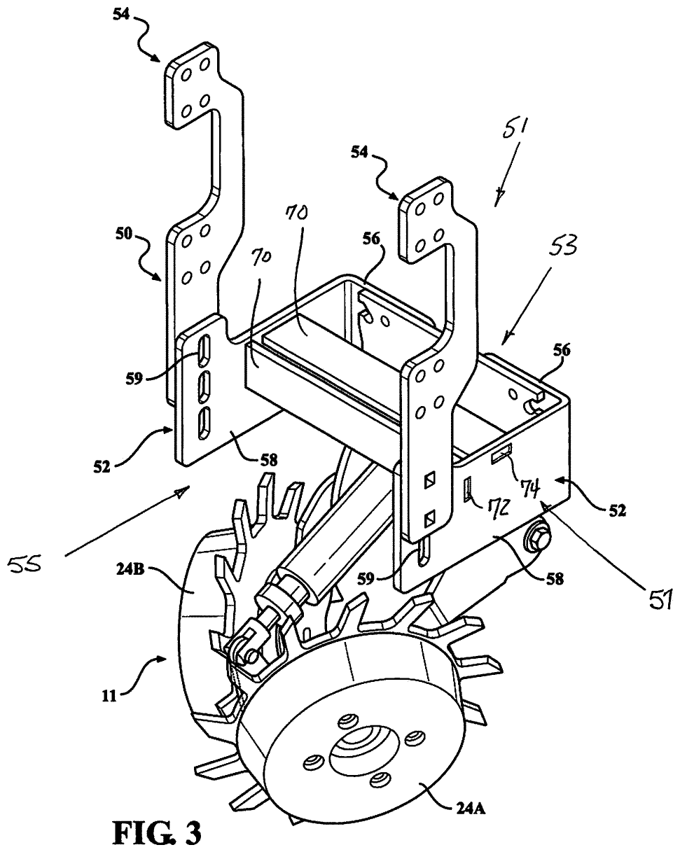

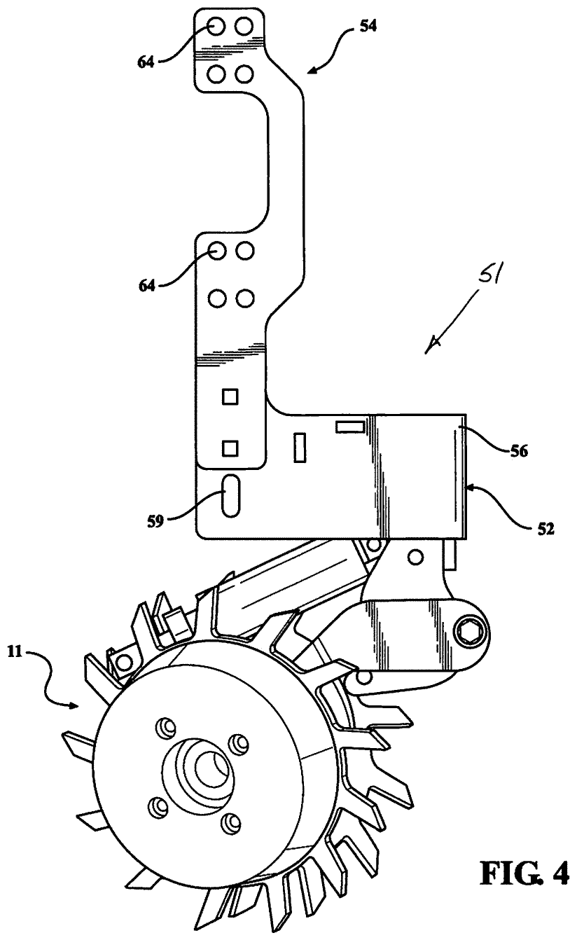

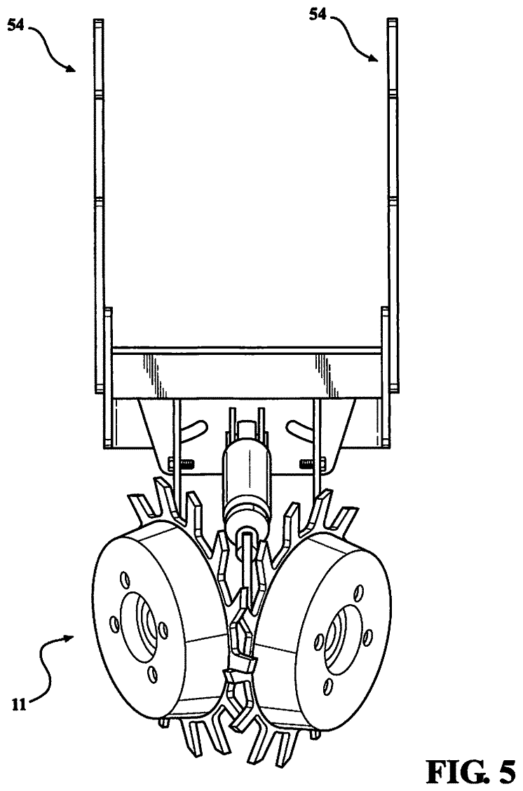

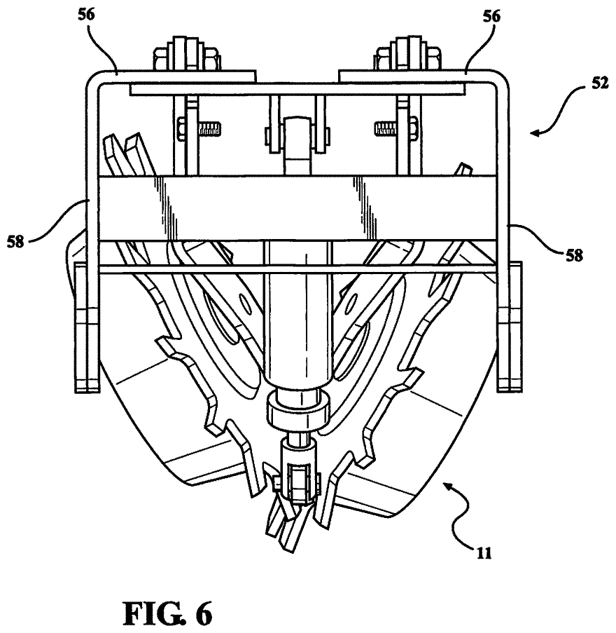

The seeding residue manager conversion kit is shown generally at 50 in FIGS. 3 through 6. The debris or residue clearing apparatus 11 is different than the apparatus 11 of FIGS. 1 and 2 to show the versatility of the conversion kit 50. It will work on many different seeding unit mounted apparatus 11, basically being a universal conversion kit 50. The conversion kit 50 includes a mounting frame 51 having a device section 53 and tool bar section 55. A central portion 57 includes side members 52. Bracket arms 54 extend from the tool bar section 55 for mounting the conversion kit to a toolbar 20. The side members 52 are generally L-shaped with a foot portion 56 and leg portion 58. The bracket arms 54 are attached to the legs 58. As illustrated, the legs 58 have slotted openings 59 to allow the brackets 54 to be adjusted for different mounting positions. The mounting bracket 27 of the clearing apparatus 11 is mounted to the back sections 56 of the side members 52. In the disclosed embodiment, the mounting bracket 27 of the clearing apparatus 11 is mounted to the device section 53 by nuts and bolts 60, and more specifically as illustrated to the foot portions 56 or in the alternative to a plate (not Shown). With reference to FIG. 2, the plate 62 is removed and the foot portions 56 replace the plate 62. Alternatively, the plate 62 can remain attached to the mounting bracket 27 and the foot portions 56 of the side members 52 can be mounted to the plate 62.

The bracket arms 54 as disclosed have an opening for receipt of the tool bar 20. Holes 64 receive fasteners to mount the brackets arms to the tool bar 20. They can be secured by conventional couplers.

In the disclosed embodiment, cross braces 70 extend between the sides 58 to strengthen the conversion kit 50. As illustrated, the braces 70 have tabs 72 that are received in slots 74 formed in the side members 52.

As will be appreciated by those of ordinary skill in the art. The conversion kit 50 is easy to ship and assemble. There are only 6 pieces which generally can be stacked and nested for shipping. The conversion kit 50 can be initially assembled by connecting the cross braces 70 and the bracket arms 54. The residue device 11 can then be attached.

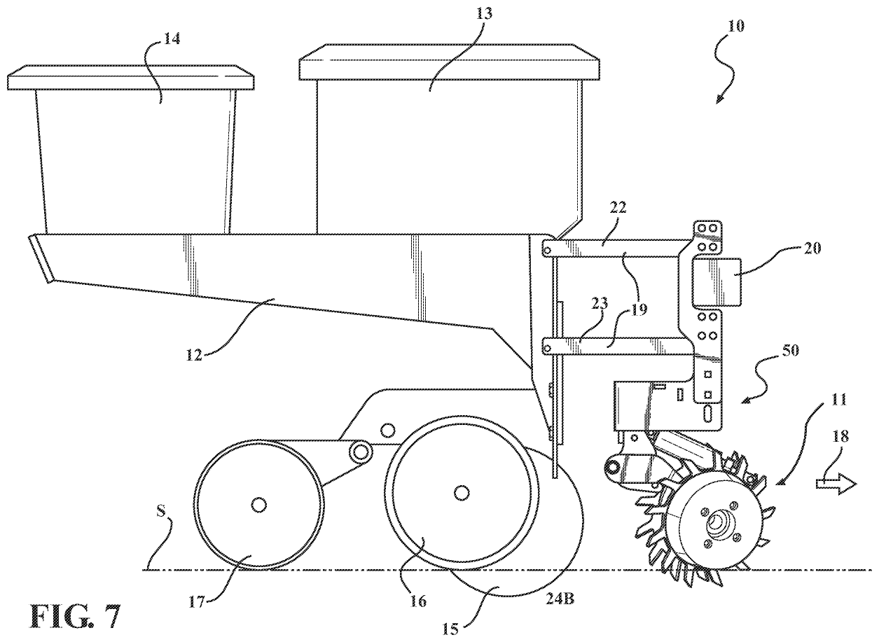

With reference to FIG. 7, the conversion kit 50 is shown mounted to the tool bar 20. Mounting the residue manager 11 to the conversion kit 50 and then to the toolbar 20 takes the weight off the row unit and doesn't negatively affect the ride of the seeding planting unit 10.

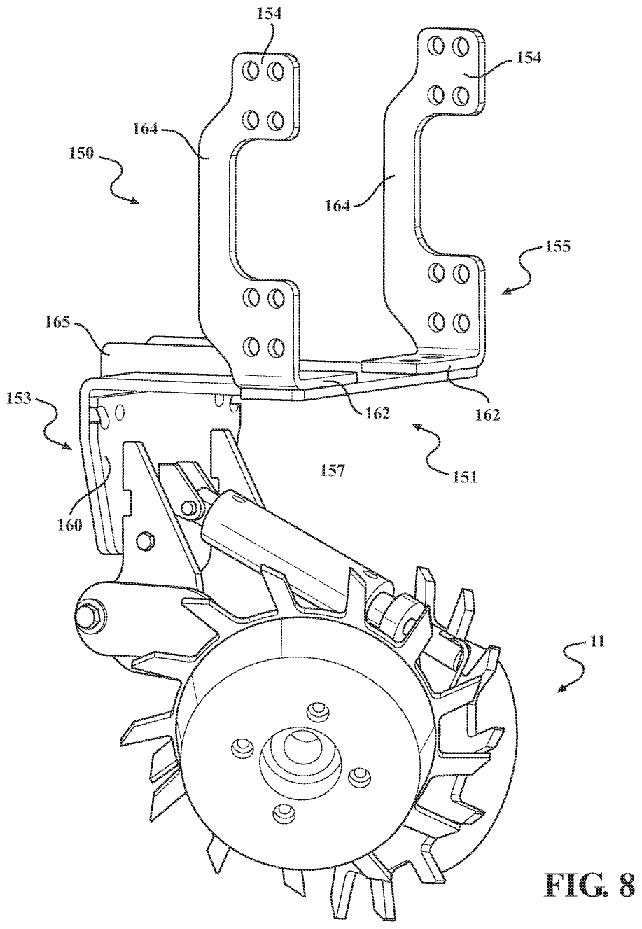

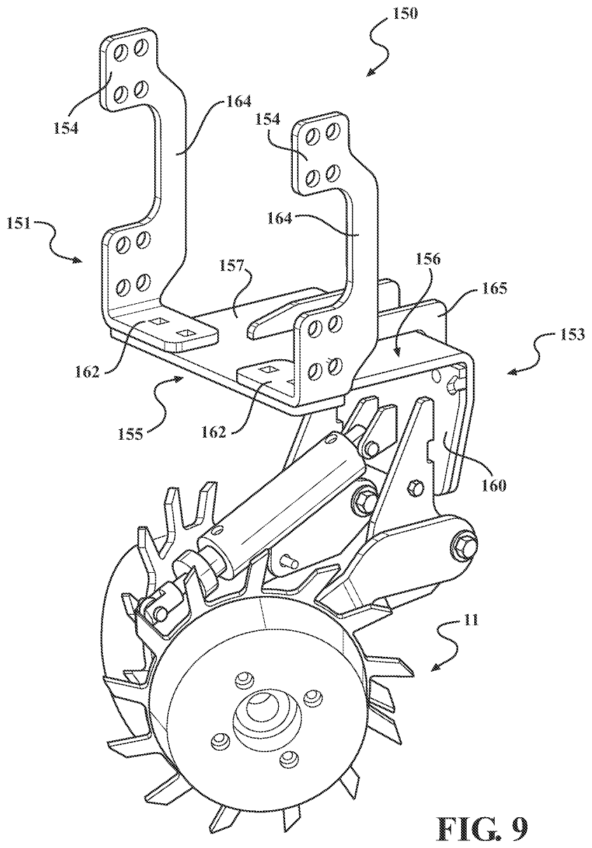

With reference to FIGS. 8 and 9, a further embodiment of the seeding residue manager conversion kit of the present invention is shown generally at 150. The conversion kit 150 includes a mounting frame 151 having a device section 153 and tool bar section 155. A central portion 157 includes bracket arms 154 that extend from the tool bar section 155 for mounting the conversion kit 150 to a toolbar 20. The mounting bracket 160 of the residue device 11 mounts to the device section 153 by for example nuts and bolts. In this embodiment, the bracket arms 154 are connected to the central portion 157 by for example welding, rivets or nuts and bolts. The bracket arms 154 are generally L-shaped having a foot 162 and leg section 164. In this embodiment, a brace or support 165 extends between the central section 157 and the device section 153 to provide added strength to the conversion kit 150.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A conversion kit for a debris clearing device, comprising:
a mounting frame having a device section for receipt of a seeding unit mounted debris clearing device; said device section having a first mount adapted for connection of a seeding unit mounted debris clearing device to said device section of said mounting frame;
a tool bar section spaced from said device section, said tool bar section having a second mount for attachment of said mounting frame to a tool bar;
a central section connecting said device section and said tool bar section;
whereby a seeding unit mounted debris clearing device is adapted to be mounted to said device section of said conversion kit and then mounted to a tool bar instead of a seeding unit of an agricultural device.

2. The conversion kit of claim 1, wherein said central section includes first and second side members joining said device section and said tool bar section.

3. The conversion kit of claim 2, wherein said first and second side members are generally L-shaped.

4. The conversion kit of claim 2, wherein each of said first and second side members has a leg portion and a foot portion, each of said foot portions being generally perpendicular to a respective one of said leg portions.

5. The conversion kit of claim 4, wherein said foot portion of each of said first and second side members are joined to form said device section.

6. The conversion kit of claim 2, further including cross braces interconnecting said first and second side members.

7. The conversion kit of claim 1, wherein said second mount includes at least one mounting bracket for mounting said mounting frame to a toolbar.

8. The conversion kit of claim 7, wherein said at least one mounting bracket and said side members include slotted openings and apertures for adjustably mounting said mounting bracket with respect to said side member.

9. The conversion kit of claim 1, further including a support brace extending between said central section and said device section.

10. A debris clearing device conversion kit for a seeder, comprising:
a seeder having a seeding unit, a seeding unit mounted clearing device, and a tool bar;
said conversion kit having a device section, said seeding unit mounted debris clearing device is mounted to said device section;
a tool bar section spaced from said device section, said tool bar section is mounted to said tool bar;
a central section connecting said device section and said tool bar section;
whereby a seeding unit mounted debris clearing device is mounted to said device section of said conversion kit instead of said seeding unit.

11. The conversion kit of claim 10, wherein said central section includes first and second side members joining said device section and said tool bar section.

12. The conversion kit of claim 11, wherein said first and second side members are generally L-shaped.

13. The conversion kit of claim 11, wherein each of said first and second side members has a leg portion and a foot portion, each of said foot portions being generally perpendicular to a respective one of said leg portions.

14. The conversion kit of claim 13, wherein said foot portion of each of said first and second side members are joined to form said device section.

15. The conversion kit of claim 11, further including cross braces interconnecting said first and second side members.

16. The conversion kit of claim 10, further including a pair of mounting brackets interconnecting said tool bar section to said toolbar.

17. The conversion kit of claim 16, wherein said mounting brackets and said side members include slotted openings and apertures for adjustably mounting said mounting brackets with respect to said side member.

18. The conversion kit of claim 10, further including a support brace extending between said central section and said device section.
